(19) United States
(12) Patent Application Publication
(10) Pub. No.: US 2012/0095875 A1
(43) Pub. Date: Apr. 19, 2012

(54) METHOD AND APPARATUS TO FACILITATE A PURCHASE OF A PRECIOUS MATERIAL

(75) Inventors: Louis T. Guthrie, Humble, TX (US); Kevin Scruggs, Tomball, TX (US)

(73) Assignee: KING SOL TECHNOLOGIES, INC., Spring, TX (US)

(21) Appl. No.: 13/162,268

(22) Filed: Jun. 16, 2011

Related U.S. Application Data
(60) Provisional application No. 61/394,288, filed on Oct. 18, 2010.

(51) Int. Cl. G06Q 30/00; G06Q 40/00

(52) U.S. Cl. 705/26.61; 705/41

(57) ABSTRACT

A secure method and reverse vending machine to facilitate the formation of a contract to purchase an article comprising a precious material from a user comprising providing a kiosk for public access, receiving an article from a user on a first member, determining a property of the article, communicating a preliminary offer to the user, receiving authorization from the user to retain the article within the kiosk, collecting and inspecting the article, communicating an offer to purchase to the user, receiving the user's acceptance of the offer to purchase and transferring funds to the user. An embodiment of the kiosk may comprise at least one of a scale, a camera, a storage member releasably dockable with the kiosk, a telephone and/or Internet data connection, and a dispensing device for use in dispensing at least one of enclosures, debit cards, vouchers, receipts, cash and user instructions.

### STATEMENT OF RELATED APPLICATIONS

This application claims priority to and depends from U.S. Provisional Application No. 61/394,288 filed Oct. 18, 2010.

### BACKGROUND OF THE INVENTION

1. Field of the Invention

This application relates to an apparatus and method to facilitate a purchase of a precious material from an owner. More specifically, this application relates to an unmanned apparatus and method to receive and to securely store an article comprising a precious material, to facilitate the inspection of the article, and to facilitate the preparation of an offer to purchase the article.

2. Brief Description of the Related Art

Precious materials, such as, for example, gold, silver, platinum, palladium, rhodium and others, are generally valued based on one or more of their mass, composition, clarity, cut, and other observable material properties. Some precious materials are presently trading at historically high prices. As a result, many owners of articles comprising precious materials such as, for example, jewelry and rare coins, are willing to sell or to at least obtain an offer to purchase their articles.

Owners of such articles are often reluctant to obtain offers to purchase from traditional purchasers of articles comprising precious materials such as, for example, pawn shops, due to inconvenience or distrust. Still other owners of such articles have reservations about selling an article through conventional methods. For example, prospective purchasers of such articles, who are generally unknown to the owner, may require the owner to place the article in an envelope or package addressed to the prospective purchaser and to rely on mail carriers to deliver the article safely to the prospective purchaser. Only if the prospective purchaser receives the article can the article be inspected and an offer to purchase can then be made. Many owners of articles comprising a precious material are hesitant to send a valuable article through the mail for fear of the articles being misdelivered, lost or stolen by an unscrupulous mail carrier. Still other owners of such articles may be eager to sell but unwilling to send a valuable article via post to a prospective purchaser without first having at least a general range or estimate of a potential offer to purchase the article. Still other owners of such articles may be reluctant to sell an article comprising a precious material to a pawn shop or to a gold-buyer because these types of businesses may be suspected of preying on consumers at a time of desperate need.

There is a need for a method and an apparatus to facilitate the purchase of an article comprising a precious material from its owner. There is a need for a method and an apparatus to facilitate the purchase of an article comprising a precious material from an owner that does not rely on conventional methods that are viewed as unacceptable or suspicious to owners that want to safely and reliably determine the value of an article. There is a need for a method and apparatus to enable an owner of an article comprising a precious material to confidentially seek a preliminary offer to purchase an article and, should the preliminary offer seem promising, a method and apparatus to generate an offer to purchase the article. There is a need for a method and apparatus to securely receive, store and collect a large number of valuable articles for inspection and for subsequent generation of offers to purchase the articles. There is a need for a method and apparatus to securely receive, store and gather articles of precious materials for inspection and evaluation without an excessive risk of loss or theft of such articles. There is a need for a method and apparatus to solicit and compel an owner's interest in selling a valuable article comprising a precious material.

### SUMMARY OF THE INVENTION

Embodiments of the method and apparatus disclosed herein satisfy one or more of these needs. In a first aspect, the method comprises the steps of providing a kiosk for access by a user, receiving an article comprising at least one precious material on a first member of the kiosk, determining at least one property of the article, communicating to the user a preliminary (or conditional) offer to purchase the article, receiving a user authorization to retain the article within the kiosk, collecting the article from the kiosk, inspecting the article and communicating to the user an offer to purchase the article. In one embodiment, the method further comprises the step of receiving from the user an acceptance of the offer to purchase to form a contract to purchase the article. In one embodiment, the method further comprises the step of transferring purchase funds to the user to consummate the contract.

In one embodiment, the method may comprise providing a controller to receive, store, manage, manipulate and process data. In one embodiment, the method may further comprise the steps of photographing the article to create an image of the article, and electronically storing the image of the article on a computer-readable storage device. In another embodiment, the method may further comprise the steps of photographing the user to create an image of the user and electronically storing the image of the user on a computer-readable storage device. In another embodiment, the method may further comprise the steps of photographing both the article and the user to create photographic images of the article and the user, and electronically storing the images of the article and the user on a computer-readable storage device.

In another embodiment, the method may comprise the step of disposing, or temporarily disposing, a barrier between the article comprising a precious material and the user, or between the first member of the kiosk and the user, to at least temporarily impair user access to the article during the step of determining a property of the article. In one embodiment, the barrier may be a transparent or opaque plexi-glass, plastic, vinyl or glass member movable between a blocking position and a removed position using an actuator such as, for example, an electric motor or a fluid (hydraulic or pneumatic) cylinder. In another embodiment, the barrier may be a screen or mesh member movable between a blocking position and a removed position using an actuator such as, for example, a fluid cylinder or an electric motor. In another embodiment, a barrier may be disposed between the user and the article by moving the article relative to the barrier instead of moving a barrier intermediate the article and the user. For example, but not by way of limitation, an article comprising a precious material may be disposed into a chute that moves the article to a first member that is inaccessible to the user to thereby prevent or limit user access to the article and/or the first member during the step of determining a property of the article. As another example, the article may be disposed on a conveyor that moves the article to a first member that is inaccessible to the user to prevent or limit user access to the article during the step of determining a property of the article.

In another embodiment of the method, the step of determining a property of the article comprising a precious material may comprise determining the mass of the article using, for example, but not by way of limitation, a scale to measure the weight of the article. In another embodiment of the method, the step of determining a property of the article may comprise determining the conductivity of at least a portion of the article using, for example, an ohmmeter, a potentiometer, a hypotentiometer and/or a resistometer. In another embodiment of the method, the step of determining a property of the article may comprise determining the hardness of at least a portion of the article using, for example, a micro-penetration hardness-testing tool to automatically determine the content and/or composition of at least one material of which the article is comprised.

In another embodiment of the method, the steps of determining a property of the article may comprise the steps of obtaining a photographic image of the article, using a controller to receive the photographic image and to compare the photographic image of the article to a number of images available to the controller such as, for example, residing in a computer-readable database, and matching the photographic image of the article with a substantially similar photographic image from the database which may be, for example, of a known article having a generally known value. For example, but not by way of limitation, an embodiment of the method may comprise obtaining a photographic image of an article provided to the kiosk by a user, communicating the photographic image to the controller, using the controller to run a program code to compare the image of the article to a database of known images, and identifying the nature of the article by matching the image of the article to one or more images of known articles having a known category or description. For example, using this method, an article presented to the kiosk by the user may be determined to be a ring. Once the nature of the article has been determined, the value of the article may be estimated by comparing the photographic image, again using a controller to run a program code, to a number of photographic images of rings stored in a database, and by matching the digital image of the article with a substantially similar or identical image of a ring in the database. By using this process, one or more properties of the article may be determined by correlation; that is, it may be assumed with a high degree of certainty that the article in the image has a similar property or properties as a substantially similar article for which the properties are known. This process may be used to determine of a preliminary offer to purchase the article which, when communicated to the user, may generate or further the user's interest in a proposed sale of the article to the operator of the kiosk.

In one embodiment of the method, the step of determining a property of a precious material comprising at least a portion of the article may comprise determining a property of the article by measuring the intensity, wavelength and/or the angle of reflection of light, radiation and/or matter (e.g., particles) that impinge on the article and reflects from, bounces off of and/or emitted from the article. For example, but not by way of limitation, an instrument may be used to measure the speed of small particles that impinge on the article at a known speed, angle and/or direction, or an optical instrument may be used to measure the amount of light from a known source of a known luminescence that is reflected by the article to the optical instrument.

In one embodiment of the method, the steps of determining a property of the article may comprise the steps of using a controller and program code to receive a user's indication of a type, nature, material, size and/or composition of the article and/or to receive a value assigned to such user indication, and then using the user indication and/or the value to determine a preliminary offer. For example, but not by way of limitation, before (or after) depositing an article comprising a precious material on the first member of the kiosk, a user may be prompted by the controller, using a monitor, display or touch-sensitive display screen to communicate a prompt, to enter a composition of the article. In one embodiment of the method, the controller may communicate to the user, using a monitor, display or touch-sensitive display screen, a plurality of user-selectable choices such as, for example, but not by way of limitation, “gold,” “silver” and “platinum.” The user may select one of the choices using a keyboard, keypad or a touch-sensitive display screen to indicate the composition of the precious material of which the article is comprised. A controller may receive the user indication such as, for example, gold, and the controller may then either read stored data from a computer readable storage medium to obtain a value for that particular precious material such as, for example, $1,000 per ounce (or $35.27 per gram), or it may communicate using, for example, a network or cellular telephone systems, with an accessible source of data to obtain a value for that particular precious material. The controller may then use the obtained value in combination with a signal received from a scale or other instrument or device coupled to the first member to provide the mass or some other property of the article to the controller, and the controller may generate a preliminary offer to purchase the article based on the user's indication of the material composition of the article. As stated in the example, the preliminary offer may, in one embodiment of the method, be determined based on the user indication of the composition taken in combination with a second determined property of the article, such as the mass, the conductivity or the size of the article. In another embodiment of the method, information relating to the value of precious materials such as, for example, the market value on a unit weight basis of one or more precious materials, may be uploaded or input into a controller in the kiosk by representatives of the operator of the kiosk, for example, upon collecting from the kiosk articles that were brought to the kiosk by prior users and retained within the kiosk with the authorization of the prior users. In still other embodiments of the method, the data relating to the value of one or more precious materials may be stored on an electronically detectable transponder(s) disposed, for example, on the second member, and which may, in one embodiment, be interchanged from the kiosk to remove articles retained within the kiosk. The electronically detectable transponder(s) may be updated with new values relating, for example, to the mass unit value of common precious materials, affixed to or disposed on the second member before the second member is taken to the kiosk and docked, installed or attached thereto.

It should be understood that the step of determining a property of the article is not intended to mean that a property be determined with any particular degree of probability or accuracy, only that it be determined with a some amount of reliability. It will be understood that more rigorous analysis, testing and investigations may be performed after the articles are collected from the kiosk and received at a centralized inspection facility to which the articles are transported after being removed from the kiosk.

After a property of the article is determined, a preliminary offer based on, in whole or in part, one or more determined properties of the article may be generated using a controller and a program code, and the controller may then communicate the preliminary offer to the user of the kiosk. In one embodiment of the method, the step of communicating a preliminary offer to the user may comprise the steps of using a controller and a program code to generate a preliminary offer using one or more determined properties of the article such as, for example, the mass and a user indication of the precious material of which the article is comprised, and then using the controller to display the preliminary offer on a user-readable monitor, display screen or touch-sensitive display provided on or in the kiosk, or to otherwise communicate the preliminary offer to the user such as by, for example, using the controller, a program code and a telephone to generate and send a text message to the user's cell phone. In another embodiment, the steps of communicating a preliminary offer to the user may comprise the step of using a controller and a program code to generate a preliminary offer using one or more determined properties of the article, and by using the controller and a program code to control a connected printer on or in the kiosk to print the preliminary offer on a printable medium such as, e.g., a piece of paper or a card, and then dispensing the printable medium to the user. The printer may comprise, but is not limited to, a dot matrix printer, laser printer, ink-jet (bubble-jet), LCD/LED, solid ink, dye sublimation, and digital photo printers. In one embodiment of the method, a printable medium dispensed to the user may also bear one or more of an image of the article belonging to the user and made the subject of the preliminary offer, information relating to the article such as, for example, the user indication of the precious material of which the article is comprised, the determined mass or weight of the article, the nature or type of article such as, for example, ring, pin or coin, and a chart or graph depicting a range of possible offers to purchase that could be made after further inspection and evaluation of the article. In one embodiment of the method, the printable medium may comprise a machine-readable bar code or a matrix (2-D) code providing information relating to the article and/or to the preliminary offer to purchase the article. For example, such a dispensed printable medium may be scanned, using a laser or optical scanner connected to a controller to run a program code and to identify a proposed transaction, a user and/or an article owned by the user upon return of the user to the kiosk to, for example, accept an offer to purchase that has been communicated to the user, or to authorize retention of the article within the kiosk. It should be understood that these same types of information, images, charts, graphs, etc. may be electronically sent to the user for example, but not by way of limitation, via text or email message using the controller to run a program code to compose the message, and by using the controller to run a program code to operate an email program or a telephone coupled to a network to send the message composed by the controller.

In one embodiment of the method, the printable medium dispensed from the kiosk to the user to communicate the preliminary offer to the user, or the text or computer-generated voice message sent from the kiosk to the user's cell phone, may also bear or provide information enabling the user to later retrieve an offer, from the operator of the kiosk, or its agent or associate, to purchase the article from the user. For example, but not by way of limitation, the printable medium or text/voice message may provide the user with an Internet website and an offer access code, an email address and an offer access code, a phone number and an offer access code, or a text number and an offer access code. After authorizing retention of the article in the kiosk, the user may retrieve the offer to purchase the article using at least one of a network (e.g., Internet) website, an email address, a text number or a telephone number, in combination with the offer retrieval code delivered via the network, email, text or telephone, respectively, to retrieve an offer to purchase the article that corresponds to the code that was provided to the user. In one embodiment, the offer to purchase may be delivered by a representative of the operator of the kiosk providing the offer to purchase verbally and communicating the offer to purchase to the user via telephone. Similarly, such acceptance or rejection of the offer to purchase may be communicated by the user to a representative of the operator of the kiosk by telephone.

In one embodiment of the method, a printable medium dispensed to the user may bear an image of the article. In one embodiment, the printable medium dispensed to the user may bear additional information relating to the proposed purchase or sale of the article including, but not limited to, the location of the kiosk, the time and/or the date of deposit of the article onto the first member of the kiosk, the image of the article, the amount of the preliminary offer that has been communicated to the user, the image of the user, and/or any combination of these.

In another embodiment of the method, the step of communicating a preliminary offer to the user may comprise the steps of using a controller to generate a preliminary offer using at least one determined property of the article, and then using the controller and a connected speaker to audibly communicate the preliminary offer to the user using a computer-generated speech program code residing on or run by the controller and a speaker electronically coupled to receive an output signal from the controller as it runs or after it runs the computer-generated speech program code.

In one embodiment of the method, information relating to the article such as, for example, a photographic image of the article, the mass of the article and/or the user indication of the precious material of which the article is comprised, may be communicated, using a controller to run a program code and a network, to an on-line merchandising website or an on-line auction website such as, for example, www.eBay.com, and one or more offers to purchase the article from third-parties that may receive information relating to the article through a network may be considered and/or adjusted by the kiosk operator in generating an offer to purchase to be communicated to the user. For example, but not by way of limitation, a third-party offer to purchase the article may be received by the operator of the kiosk prior to its communication of an offer to purchase the article to the user, and the kiosk operator may generate its offer to purchase the article in reliance on the willingness of a third-party to pay a certain price for the article, thereby leaving a profit to be made by the kiosk operator by reducing the offer to purchase provided by the third-party using a network and then making an offer to purchase the article to the user. In another example, an offer to purchase the article may be received from a third-party and by the operator of the kiosk after the operator of the kiosk has communicated an offer to purchase the article to the user and after the user has rejected the offer to purchase, but before the return of the article to the user. In this event, the operator of the kiosk may wish to revise and increase its offer to purchase the article and to communicate the revised and increased offer to purchase the article to the user in reliance on the willingness of a third-party to pay a certain price for the article. The increased offer to purchase may be communicated to the user in any of the methods that have been disclosed herein for communicating the first or original offer to purchase.

In one embodiment of the method, the step of communicating a preliminary offer to the user may comprise the steps of using a controller to run a program code to generate a preliminary offer to purchase the article using a determined property of the article, using the controller to run a program code to display a request for the user to input contact information such as, for example, a cellular telephone number or an email address, into the controller, using the controller to run program code to receive the contact information, for example, the cellular telephone number or email address, from the user through, for example, a user-accessible keyboard, a keypad, or a touch-sensitive display disposed on the kiosk, and then by using the controller to run a program code to use the contact information, for example, to operate a telephone electronically coupled to the controller to generate and send the preliminary offer to the user in a text message sent to a cellular telephone number provided by the user, in an email sent to an email address provided by the user, and/or by using the controller and a computer-generated speech generation program code run on the controller to generate a signal to a speaker or to a telephone electronically coupled to the controller to place a call and, upon detecting completion of the call, to generate a computer-generated voice message to the user using the user's cellular telephone. Alternately, the controller may electronically communicate with a network (such as, for example, the Internet) and use with an email program residing on a network to generate and then send a written message to the email address provided by the user.

If the user favorably receives the preliminary offer to purchase the article, the user may authorize retention of the article within the kiosk for subsequent collection and inspection of the article by the kiosk operator to support an offer to purchase. In one embodiment of the method, the step of receiving a user authorization to retain the article within the kiosk may comprise the steps of using a controller to run a program code to receive a user authorization through, for example, a keyboard, keypad or touch-sensitive display electronically coupled to the controller and disposed on or in the kiosk. The controller may run a program code to receive and identify or recognize a user authorization to retain the article in the kiosk, and in response to identifying or recognizing an authorization response, the controller may run a program code to actuate a device to move the article to the second member of the kiosk for storage. In another embodiment of the method, the step of receiving a user authorization to retain the article within the kiosk may comprise using a controller to detect a user's manipulation of one or more user-accessible keys, buttons or levers disposed on or in the kiosk such as, for example, a lever that is movable by the user to cause the article to be moved to a second member of the kiosk in which the article may be stored for later collection and inspection by the kiosk operator. In another embodiment of the method, the step of receiving a user authorization to retain the article within the kiosk may comprise using a controller to run a speech-recognition program code to detect, interpret and/or record a user-spoken authorization provided to the controller using, for example, a speaker disposed on the kiosk or in a telephone handset located on the kiosk, or a speaker on a cellular telephone electronically connected to the controller.

In one embodiment of the method, the step of receiving a user authorization to retain the article within the kiosk may comprise the step of using a controller to run program code to receive contact information from the user. In this embodiment, the user's input of contact information may be received by the controller and interpreted or accepted by the controller as a bona fide substitute for or as an indication of the user's authorization to retain the article within the kiosk since, absent authorization to retain the article, no user contact information is needed. The user may provide contact information to the controller such as, for example, a telephone number, a cellular telephone number, an email address, a mailing address or a fax number, to which an offer to purchase the article may be communicated after the article is collected and inspected by the operator of the kiosk. The controller will run program code to store the user's contact information received from the user on a computer readable storage medium and to associate the contact information with the article retained within the kiosk with user authorization, and a controller will later run program code to retrieve and use the user's contact information to communicate an offer to purchase to the user after the associated article is collected and inspected.

In one embodiment of the method, the step of receiving a user authorization to retain the article within the kiosk may comprise the step of using a controller to receive the user's request for dispensation from the kiosk of an information storage medium such as, for example, a printable medium or an electronic and/or magnetic storage medium. In one embodiment, a printable medium may comprise a piece of paper or a card suitable for printing thereon, a coupon or a redeemable voucher. In one embodiment, an electronic or magnetic storage medium may comprise a card comprising a magnetic data storage strip, a card comprising a computer-readable chip, or a debit card. In one embodiment of the method, the step of using a controller to run program code to receive a user authorization to retain the article within the kiosk may be followed by the step of using the controller to run program code to provide instructions to the user on how to use information stored on the information storage medium to later communicate with the kiosk operator to obtain an offer to purchase the article. For example, but not by way of limitation, an information storage medium, such as a printable medium, dispensed from the kiosk to the user at the time of receiving the user authorization may provide the user with printed instructions enabling the user to later access an offer to purchase the article. In one embodiment of the method, the instructions on the information storage medium may enable the user to later access the offer to purchase the article by revisiting and using the kiosk, or by visiting and using another affiliated kiosk. For example, the information storage medium may comprise a printable medium bearing a numeric or alphanumeric code, a bar code or a matrix (2-D) code that identifies the article and/or the proposed transaction relating to the article, and the user may obtain the offer to purchase using the information stored in the code or on the information storage medium. For example, but not by way of limitation, an embodiment of the method may comprise the steps of collecting and inspecting the article retained within the kiosk, using a controller to run program code to associate an offer to purchase with the article and with the information stored on an information storage medium dispensed to the user upon receiving the authorization to retain the article within the kiosk, using the controller to run program code to receive a code from the user (or from a scanner used by the user to read information stored on an information storage medium) using a controller to retrieve the offer to purchase associated with the code that is on the information storage medium provided to the user and using the controller to run program code to communicate the offer to purchase associated with the article and with the code to the user. For example, but not by way of limitation, an offer to purchase the article associated with the code on the information storage medium presented by the user may be stored on a computer readable storage medium and made available to the kiosk through a network. Upon revisiting the kiosk (or an affiliated kiosk) to obtain the offer to purchase the article, the user may position the information storage medium and the code thereon adjacent a laser scanner or optical scanner/reader disposed on the kiosk. An embodiment of the method may comprises the steps of activating a controller to run a program code to scan the numeric or alphanumeric code, bar code or Matrix (2-D) code, using a controller to then run program code to compare the scanned code to a database and using a controller to retrieve an offer to purchase relating to that article or to that transaction from the computer readable storage medium using the network. The controller will then run program code to display the offer to purchase to the user and, optionally, to request the user to provide an acceptance or a rejection of the offer to purchase.

In an alternate embodiment of the method, a controller may run program code to dispense an activatable debit card bearing a code relating to the transaction and/or proposed transaction to the user upon receiving authorization from the user to retain the article within the kiosk. In one embodiment of the method, the user may later return to the kiosk (or to an affiliated kiosk) and scan and/or insert the activatable debit card into the kiosk to communicate a code on the debit card to the controller. The controller then runs a program code to identify the article, the transaction and/or the proposed transaction relating to the article, the controller runs a program code to retrieve the offer to purchase and the controller runs a program code to communicate the offer to purchase to the user. In one embodiment of the method, the controller may then run program code to request the user's response to the offer to purchase, the controller may run a program code to receive the user's acceptance of the offer to purchase and then the controller may run program code to enable or activate the debit card in the amount of the offer to purchase.

In another alternate embodiment of the method, upon receipt of the user's authorization to retain the article within the kiosk, a controller may run program code to dispense an information storage medium bearing a detectable code to the user. The detectable code may comprise a laser detectable code, an optically detectable code, or an electronically, magnetically or electromagnetically detectable code, such as a code stored on a chip, RFID or on a magnetic strip. The user may later revisit the kiosk (or an affiliated kiosk) with the information storage medium and present it as described above to enable the controller to run program code to identify the article, the proposed transaction or the transaction relating to the article. The controller may then run program code to retrieve from a computer readable storage medium and to communicate to the user, as described above, the offer to purchase the article. The controller may then run program code to receive and interpret a signal corresponding to the user's acceptance of the communicated offer to purchase, the controller may run program code to dispense to the user a redeemable voucher and/or coupon bearing a code thereon indicating the amount of the offer to purchase, and the user may present the voucher and/or coupon to an affiliated retailer for redemption, for example, to obtain cash or equivalent value. In one embodiment of the method, the affiliated retailer may redeem the voucher and/or coupon for gift cards or credit that may be used to obtain goods and/or services from the affiliated retailer.

In another embodiment, the information storage medium dispensed to the user from the kiosk at the time of receiving the user's authorization to retain the article within the kiosk may provide information to the user enabling later access to an offer to purchase the article by using an Internet-accessible website, a telephone number, a text number or an email address owned by or belonging to the kiosk operator.

The term “information storage medium,” as that term is used herein, may include information stored by printing, etching and marking, and includes information stored electronically, magnetically, electromagnetically or otherwise. It is within the scope of the invention that the “information” stored on the information storage medium is not necessarily available to, readable by or accessible by the user, but may instead be in a form that cannot be understood upon visual inspection, such as, for example, a bar code or a matrix (2-D) code that may be readable using a controller to run a program code to detect and read a signal from a connected optical and/or laser scanning device. Optionally, the information stored on the information storage medium may be stored electronically and/or digitally on, for example, a flash drive, a compact disc, a computer-readable chip or a floppy disc. Optionally, the information stored on the information storage medium may be stored electronically and/or magnetically on, for example, an electronically detectable and/or magnetically detectable and computer-readable transponder or a magnetic strip. In some embodiments of the method, it is not necessary that the user be able to access and read information stored on the information storage medium, but it may be necessary that the user be able to provide the information (stored in an unavailable or non-accessible format or form on the information storage medium) to others, such as to the kiosk operator or an associated retailer, such as a grocery store or department store, in order to take an additional step towards consummation of a transaction involving the sale of the article.

After the user authorizes retention of the article within the kiosk, the method may comprise the step of moving the article to a second member for secure storage within the kiosk until the article can later be collected from the kiosk and inspected. In one embodiment of the method, the step of storing the article within the kiosk comprises moving the article to a second member such as, for example, a storage member. In one embodiment of the method, the second member comprises a case securable in a closed position and removably dockable with or in the kiosk. For example, but not by way of limitation, the second member may comprise a case having a first member hingedly coupled to a second member, and a latch for securing the first member and second members in a closed position to prevent unauthorized access to the contents of the case. In a further example, but not by way of limitation, the second member may be removably dockable with or in the kiosk. For example, the second member may be receivable within a port or bay of the kiosk and then secured using a latch, lock or other retaining member to prevent unauthorized removal of the second member from the kiosk. Optionally, the second member may be removably receivable on or in the kiosk to become a removable component of the kiosk. In one embodiment, the second member may be securable to the kiosk and within or adjacent to a bay, an aperture, a port, a chute, a track or an opening of the kiosk through which articles may pass to be stored in the second member. In one embodiment of the method, the second member may be latched, locked or otherwise retained in a secured position on, against, within or in the kiosk to prevent unauthorized removal of the second member from the kiosk by anyone other than the kiosk operator or its authorized agent. The second member may further be secured against opening after removal from the kiosk to prevent unauthorized access to the contents of the case and, at the same time, the second member may be secured against unauthorized removal of the case from the kiosk. In one embodiment of the method, the step of providing authorization to remove the second member from the kiosk to facilitate collection and inspection of the article stored in the kiosk does not necessarily coincide with providing authorization to access the contents of the second member once it is removed from the kiosk. Access to the contents of the kiosk may be reserved to persons other than the person that removes the case from the kiosk. For example, the kiosk operator may utilize a first latch, lock or other retaining member, along with a first key or code to operate the first latch, lock or retaining member to retain the second member in or on the kiosk and to prevent unauthorized removal of the second member from the kiosk. At the same time, the kiosk operator may utilize a second latch, lock or other retaining member, along with a second key or code to operate the second latch, lock or retaining member to prevent unauthorized access to the contents of the second member, including preventing access to the articles in the second member by the person authorized to have and use the first key or code to remove the second member from the kiosk.

In another embodiment, the step of storing the article within the kiosk comprises the step of moving the article, along with the first member, to a second member. The first member may comprise a tray, a bag (for example, but not by way of limitation, a sealable bag), an enclosure, a container or a box to receive and hold the article, including when the article is moved to the second member for storage. In another embodiment of the method, the step of storing the article within the kiosk may comprise the step of removing the article from the first member and moving the article to the second member. In one embodiment of the method, the user may insert the article into an enclosure or bag prior to placing the article on the first member.

In one embodiment of the method, the step of collecting and inspecting the article may comprise the step of removing the second member in which the article is stored from the kiosk followed by the step of providing a substitute second member to be placed on, within or against the kiosk to receive subsequent articles that may be later be stored within the substitute second member of the kiosk after deposit of subsequent articles by subsequent users. In another embodiment of the method, the step of collecting and inspecting the article comprises the step of obtaining access to the second member of the kiosk followed by the step of emptying the second member of some or all of its contents. In one embodiment, the step of obtaining access to the second member comprises the step of removing the second member from the kiosk. In some embodiments, the step of removing the second member may be followed by the step of removing some or all of the contents and then the step of restoring the second member back within or against the kiosk to receive and store subsequent articles that may be later be stored within the kiosk after deposit of subsequent articles by subsequent users.

The step of collecting the article from the kiosk may comprise steps associated with unlatching, unlocking or otherwise releasing the second member from the kiosk, and that this step may comport with embodiments of the second member described above in relation to the step of storing the article in a second member.

In one embodiment of the method, the step of communicating an offer to purchase the article to the user comprises the step using a controller to run program code to store an offer to purchase the article on a computer-readable storage medium in a manner such that the offer to purchase the article is associated, within a database accessible to a controller, with at least one of a code specific to the article, a code specific to the transaction, a code specific to the user, a photographic image of the article, a photographic image of the user, a phone number, a cellular phone number, a mailing address, a fax number and a frequent user account.

In another embodiment of the method, the step of communicating an offer to purchase the article to the user comprises the step of using a controller to run a program code to communicate an offer to purchase the article to the user by way of, for example, an Internet website, a telephone or cellular telephone cooperating with a computer-generated speech program, a cellular telephone to receive and display a controller-generated text transmission, a fax machine cooperating with a controller to receive and print a controller-generated facsimile transmission (either telephonic or electronic via network), or a controller and a display monitor cooperating to receive and display a controller-generated email message. The step of communicating an offer to purchase to the user using, for example, a text transmission, a fax or an email, may comprise the steps of providing a numeric or alphanumeric code, a matrix (2-D) code or a bar code to the user for retention and presentation by the user to a numeric or alphanumeric code, matrix (2-D) code or bar code scanner/reader accessible to the user at, for example, the kiosk, an affiliated kiosk, or at the checkout counter or courtesy booth of a retailer associated with the operator of the kiosk, for example, a grocery store or department store. In one embodiment, an offer to purchase the article may be communicated to the user by providing a telephone number to the user and by providing an operator to answer the user's call, receive the user's code and to provide the offer to purchase corresponding to that code by telephone. In one embodiment, an offer to purchase the article may be communicated to the user by providing a telephone number to the user and by providing a controller to run program code comprising a speech-recognition program and program code comprising a computer speech-generation program to automatically communicate with the user, to receive the user's code and to provide the offer to purchase corresponding to that code. As an alternative to the speech-recognition code, the controller may run program code to detect and interpret a code input by the user using buttons on the telephone keypad, each of which, when activated by touch, provides a tone at a computer-detectable frequency.

In one embodiment of the method, for example, the user may access an Internet website and then use a keyboard or other input device connected to and cooperating with a personal computer and electronically connected to the Internet through, for example, a modem and telephone lines or cable television transmission lines, and the user may use the Internet access to enter a code specific to the user's transaction or article. In response to the user's entry of the code, a controller may be used to run program code to retrieve from a database an offer to purchase the article corresponding to the code entered by the user, and the controller may be used to display on the user's monitor or Internet access device screen an offer to purchase the article. In one embodiment of the method, the controller may be used to run program code to display on the user's monitor or Internet access device screen a first clickable icon for use by the user in accepting the offer to purchase the article and a second clickable icon for use by the user in rejecting the offer to purchase the article. The controller may be used to run program code to detect the user's response, whether it be by clicking on a displayed icon or by entering a code to indicate the user's response and, in response to the user's selection of the first clickable icon to accept the offer to purchase, the controller may be used to run program code to display to the user, again on the user's monitor or Internet access device screen, a plurality of options for transferring purchase funds to the user. Alternately, in response to the user's selection of the second clickable icon to reject the offer to purchase, a controller may be used to run program code to display to the user a prompt to provide information such as a mailing address to enable the operator of the kiosk or its agent to return the article to the user or, optionally it may display a previously-provided address to which the article will be mailed unless the user changes such address.

In another embodiment of the method, the step of communicating the offer to the user may comprise the steps of using a controller coupled to a telephone or a cellular telephone to dial the user's number, using the controller to run program code to detect an answer to the call, and then the step of audibly delivering the offer to purchase the article to the user using a controller to run a program code comprising a controller-generated speech program. Optionally, the controller may be used to run a computer-generated speech program to communicate additional information to the user other than, and in addition to the offer to purchase the article such as, for example, but not by way of limitation, the date and/or time that the article was deposited into the kiosk, the location and/or address of the kiosk into which the article was deposited, and/or the nature and/or size of the article (for example, a ring, a necklace or a coin).

In some embodiments of the method, the step of communicating the offer to the user may comprise the step of using a controller coupled to a telephone to run a computer-generated speech program and to thereby prompt the user to use his or her telephone to authorize telephonic delivery of the offer to purchase the article by entering a code into the controller using the telephone or cellular telephone keypad or by speaking a code into his or her telephone. In the latter embodiment of the method, the controller may be used to run a speech-recognition program to detect and interpret the user's spoken authorization.

In one embodiment of the method, upon receiving the keypad-generated or user-spoken code to authorize telephonic delivery of the offer to purchase the article, the offer to purchase may be delivered to the user using a controller to run a computer-generated speech program and the computer-generated speech program may then prompt the user to either enter a first code, using the telephone keypad, to accept the offer to purchase or to enter a second code, using the telephone keypad, to reject the offer to purchase. In some embodiments of the method, a controller may be used to run a computer-generated speech program to instead prompt the user to verbally respond to the offer to purchase using specific computer-recognizable speech such as, for example, but not by way of limitation, by saying “accept” or “reject” into the speaker on the telephone or cellular telephone microphone, and by then using the controller to run program code to detect and interpret the user's spoken response.

In one embodiment of the method, the step of using a controller to run program code to receive the user's acceptance of the offer to purchase the article is followed by the step of using a controller to transfer purchase funds to the user. In one embodiment of the method, the step of transferring funds to the user comprises the step of using a controller to run program code to request, either using a legible display or by running a computer-generated speech program, the user's account information relating to at least one of a checking account and a credit card account at the time of receiving the user's authorization to retain the article within the kiosk, and then later transferring purchase funds upon receipt of the user's acceptance of the offer to purchase by running a program code to electronically provide a deposit of funds to the user's designated checking account or to electronically provide a credit to the user's designated credit card account corresponding to the information provided by the user.

In another embodiment of the method, the step of transferring purchase funds to the user comprises the step of using a controller to operate a dispenser to dispense an activatable debit card from the kiosk at the time that the user authorizes retention of the article within the kiosk, and then later using the controller to run program code to electronically activate the dispensed debit card for subsequent use by the user in, for example, withdrawing funds at a kiosk or at an ATM (automatic teller machine) operated by a financial institution, for example, a bank or credit union. Alternately, the activated debit card may be used by the user to purchase goods or services at retailers that accept payment using activatable debit cards.

In another embodiment of the method, the step of transferring funds to the user comprises the step of using a controller to run program code to activate a dispenser to dispense a redeemable voucher, receipt, ticket or code from the kiosk and to the user at the time that the user authorizes retention of the article within the kiosk, and then the step of using a controller to run program code to authorize an associated retailer, such as a department store, convenience store, casino, etc., to credit or pay to the user, upon presentation of the redeemable voucher, receipt, ticket or code, and after the offer to purchase has been determined, the amount of the offer to purchase. The payment to the user may be made in cash or, alternately, in the form of a gift card or cash card for that associated retailer to enable the user to purchase services or goods at that associated retailer. In one embodiment, some associated retailers would be willing to apply a multiplying factor to the offer to purchase in order to entice the user to purchase services or goods upon or after redeeming the user's voucher, receipt, ticket or code.

In another embodiment of the method, the step of transferring funds to the user comprises the step of using a controller to run program code to request a cellular telephone number from the user at the time of receiving an authorization from the user to retain the article within the kiosk, and then later using a controller coupled to a telephone to run program code to generate a text message containing a code to the cellular telephone number provided by the user. The code may then be received by the user and then used to obtain the purchase funds. For example, but not by way of limitation, the code sent to the user using the controller coupled to a telephone to run program code and communicate the code to the user via telephone may, in one embodiment of the method, comprise a personal identification number (PIN) that may be used to activate or “unlock” an activatable or “locked” debit card that was dispensed to the user from the kiosk at the time of receiving the user's authorization to retain the article within the kiosk. Alternately, the code may be communicated to the user using a controller coupled to a telephone to run a computer-generated speech program to communicate with a telephone or cellular telephone having a number that was obtained by operator of the kiosk from the user at the time of authorizing the retention of the article within the kiosk. The controller may operate the computer-generated speech program to send a signal to the speaker on the user's telephone to “speak” the PIN to the user. The PIN may thereafter be used by the user and in conjunction with the debit card dispensed to the user from the kiosk at the time of receiving the user's authorization to retain the article within the kiosk.

In another embodiment of the method, the step of transferring funds to the user may comprise the steps of requesting the user's entry of an email address for use in enabling the operator of the kiosk to communicate to the user a code such as, for example, a PIN, enabling the user to activate and/or use an activatable debit card dispensed from the kiosk to the user at the time of receiving the user's authorization to retain the article within the kiosk, followed by the step of later using a controller to run an email program to generate and send through a network and to the user an email providing or containing the PIN. The PIN would be sent to the user's email address provided by the user at the time of authorizing the retention of the article within the kiosk.

In the various embodiments of the method, the determination of a property of the article, the determination of a preliminary offer using the determination of the property of the article, the receiving of the user's indication of the precious material of which the article is comprised, and the communication of the determined preliminary offer to the user are steps that substantially reduce the likelihood of user rejection of the offer to purchase the article that may be later generated and communicated to the user after the article is collected from the kiosk and inspected. These interactions with the user are, by their nature, a sharing of information with the user and an involvement of the user in the determination of the potential estimate of value of the article. Further, the use of a controller to run program codes to automate one or more of these steps and/or other steps enables the operator of the kiosk to eliminate users that are substantially less likely to be interested in selling an article at a fair price, and the automation of these steps saves substantial labor costs that would otherwise be incurred in collecting and inspecting the articles authorized for retention within a kiosk, substantial transportation and/or mailing costs associated with transporting and/or mailing articles to a centralized inspection location, substantial labor costs associated with inspection of the articles, and mailing or other delivery costs associated with mailing or delivering articles to users that might otherwise ultimately reject an offer to purchase. Additional benefits of the automation of these and other steps will become apparent from the disclosure that follows.

The foregoing, as well as other, objects, features, and advantages of the invention will be more fully appreciated and understood by reference to the drawings, described below, and to the claims appended hereto.

### BRIEF DESCRIPTION OF THE DRAWINGS

FIG. 1 is a flowchart illustrating one embodiment of the method of the invention.

FIG. 1A is a perspective view of an apparatus that may be used to implement embodiments of the method.

FIG. 1B is one embodiment of a first member of the apparatus of FIG. 1A bearing a grid pattern and supporting an article comprising a precious metal.

FIG. 2 is a flowchart illustrating alternate embodiments of the step of determining a property of the article deposited on the first member of the kiosk.

FIG. 3 is a flowchart illustrating alternate embodiments of the step of communicating a preliminary offer to the user.

FIG. 3A is an example of a message that may be displayed on a monitor or screen of an apparatus used to implement embodiments of the method.

FIG. 4 is a flowchart illustrating alternate embodiments of the step of receiving a user authorization to retain the article within the kiosk.

FIG. 4A is an illustration of a debit card having a magnetic strip and printed instructions that may be dispensable from an apparatus used to implement embodiments of the method.

FIG. 5 is a flowchart illustrating a device that may be used in the performance of the step of collecting the article from the deposit.

FIG. 6 is a flowchart illustrating alternate embodiments of the step of communicating an offer to purchase the article to the user.

FIG. 7 is a flowchart illustrating alternate embodiments of the step of receiving a user's acceptance of the offer to purchase the deposit.

FIG. 8 is a flowchart illustrating alternate embodiments of the step of transferring purchase funds to the user.

FIG. 8A is an illustration of an authorization code provided to the user via a text message sent to the user's cellular telephone.

FIG. 9 is a flowchart illustrating an embodiment of a method of facilitating the formation of a contract for the purchase and sale of an article comprising a precious metal.

### DETAILED DESCRIPTION OF AN EMBODIMENT

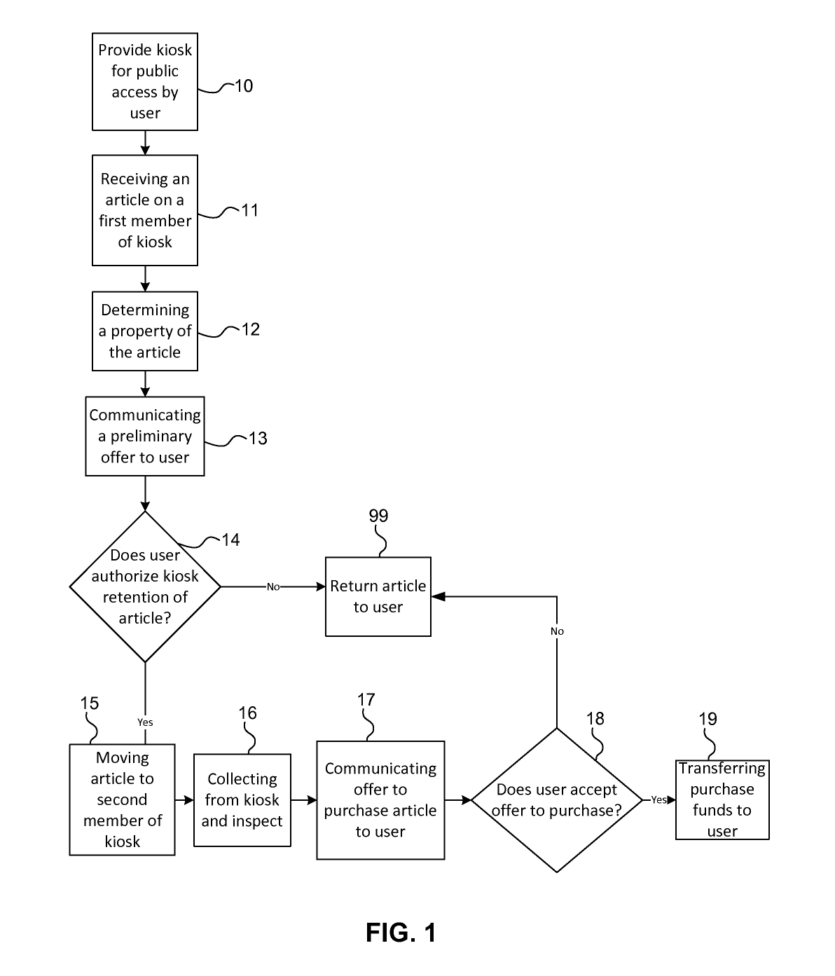

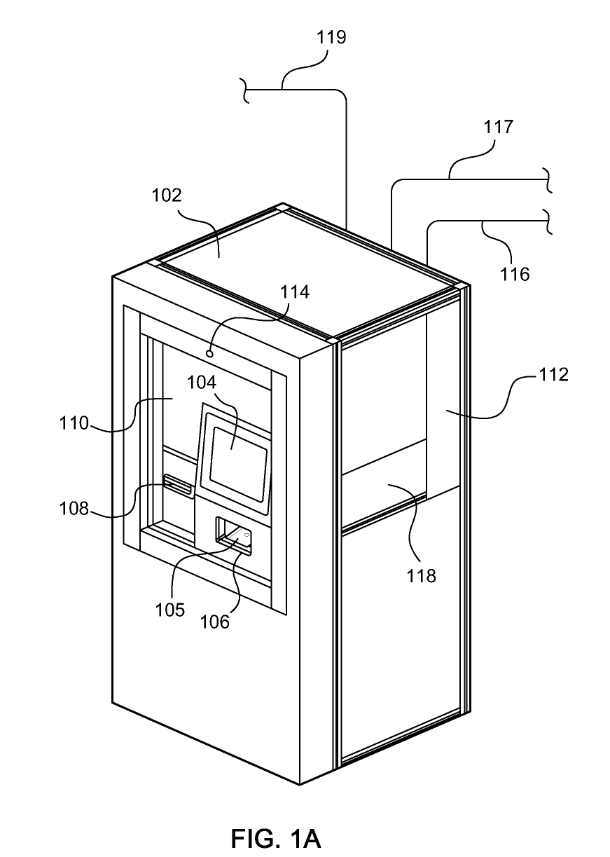

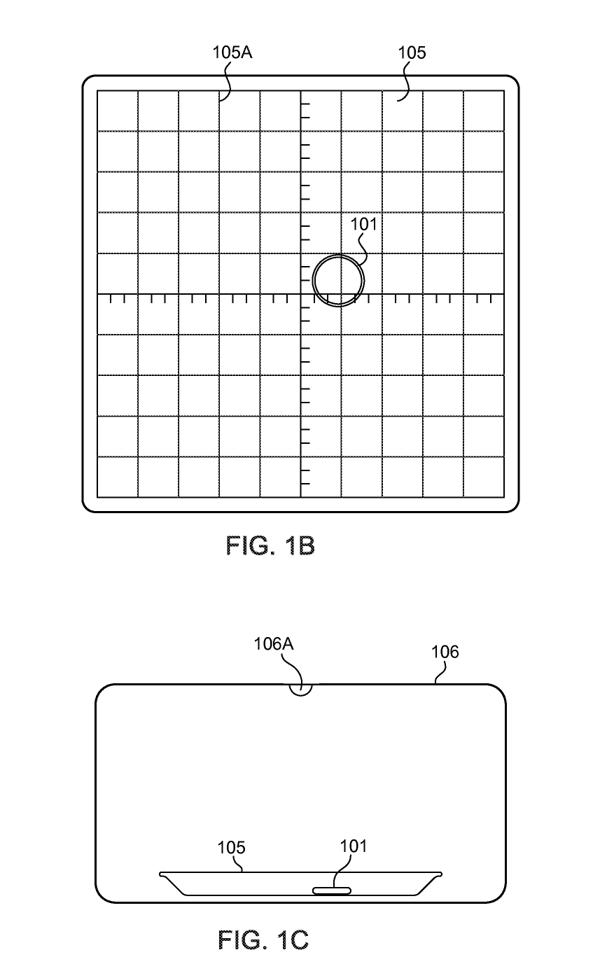

FIG. 1 is a flowchart generally illustrating the steps of a method of facilitating the purchase of an article comprising a precious material from an owner (hereinafter referred to as “a user”) using a kiosk. The method illustrated in FIG. 1 comprises the step 10 of providing a kiosk for public access to users. A kiosk of the type that may be used to implement the invention may be provided inside a structure containing retail businesses, grocery stores, public squares, malls and travel facilities such as airports, train stations, bus terminals, subway stations and casinos. In some embodiments, a kiosk may be secured against unauthorized movement or removal by securing the kiosk to a floor, wall, or retainer to prevent unauthorized removal and unauthorized access. The embodiment of the method illustrated in FIG. 1 further comprises the step 11 of receiving an article from the user on a first member of the kiosk, followed by the step 12 of determining a property of the article and then the step 13 of communicating a preliminary offer to purchase the article to the user. The embodiment of the method illustrated in FIG. 1 further comprises the step 14 of seeking user authorization to retain the article within the kiosk for collection by the operator of the kiosk and inspection to determine an offer to purchase. In the embodiment of the method where the user authorizes retention of the article within the kiosk for collection by the operator of the kiosk and inspection to determine an offer to purchase, the method further comprises the step 15 of moving the article to a second member of the kiosk for storage followed by the step 16 of collecting the article from the kiosk and inspecting the article, and the step 17 of communicating an offer to purchase the article to the user. The embodiment of the method illustrated in FIG. 1 further comprises the step 18 of seeking the user's acceptance of the offer to purchase the article. In the embodiment of the method where the user accepts the offer to purchase, the method further comprises the step 19 of transferring purchase funds to the user. In the embodiment of the method where the user does not authorize retention of the article within the kiosk for collection by the operator of the kiosk and inspection to determine an offer to purchase, and also in the embodiment of the method where the user rejects the offer to purchase the article, the method further comprises the step 99 of returning the article to the user.

The method illustrated in FIG. 1 may be implemented using an apparatus, such as a kiosk. An embodiment of an apparatus to implement the method of FIG. 1 is illustrated in FIG. 1A. As illustrated in FIG. 1A, the kiosk 102 may be made available to access to users in a walk-up or drive-through facility and may comprise a display screen 104 for use in displaying written instructions, information and/or selectable icons to the user. The display screen 104 may, in some embodiments, be provided with side panels, blinders, enclosures and viewing angle filters to prevent unwanted viewing of articles and/or unwanted viewing of the display screen 104 that may contain confidential information relating to a prospective transaction involving the kiosk 102. In one embodiment, the kiosk 102 comprises a panel 110 bearing instructions and/or advertisements. The kiosk 102 may comprise a port 106 for providing access to the first member 105 and a removable second member 112 that securely docks within the kiosk 102. In one embodiment, the kiosk 102 may comprise a camera 114 that may be used to photograph the user (not shown). The kiosk 102 may further comprise a camera (not shown) positioned above the first member 105 for use in photographing an article placed on the first member 105 by the user. In some embodiments, the kiosk 102 may comprise an electrical conduit 119 to provide electrical current to operate various components of the kiosk 102 such as, for example, the camera 114, the article camera (not shown), a controller 118, the display screen 104, and a motor to move a barrier (not shown) adjacent to the first member 105 between a blocking position to prevent user access to the first member 105 and a removed position to permit user access to the first member 105. In addition, the kiosk 102 may comprise a network connection (or data conduit) 116 and/or a telephonic data connection (or data conduit) 117, or both.

In some embodiments, the kiosk 102 may comprise a controller 118 that is coupled to and cooperates with one or more devices that may be used to determine a property of an article disposed by the user on the first member 105 of the kiosk 102 such as, for example, a network connection (or data conduit) 116, the telephonic connection (or data conduit) 117, the camera 114 and other devices including, but not limited to, a motor or fluid cylinder (not shown) coupled to move a barrier between a blocking position to impair user access to the first member 105 and a removed position to permit user access to the first member 105, a motor (not shown) to operate a conveyor or other device for moving an article to a second member 112 for storage, a data storage unit (not shown), compact disc (not shown), hard drive (not shown) or other device on which data may be stored and from which data may be retrieved.

A kiosk 102 is generally provided with a first member 105 to receive and support an article (not shown in FIG. 1A) provided to the kiosk 102 by the user and being considered for sale by the user. In one embodiment of the kiosk 102, a first member 105 may be disposed generally beneath, in a direct line of sight with or in “view” of a camera (not shown) or optical device positioned to scan, view or photograph an article placed on the first member 105. In one embodiment, the first member 105 may bear a design, grid (see FIG. 1B), pattern, gauge, or other image that may cooperate with a scanner, camera, optical member or other instrument (not shown) to determine a dimensional property of the article 101 placed thereon. For example, again referring to FIG. 1B, a grid 105A of a known spacing, oriented radially, horizontally, vertically or otherwise, and having sufficient contrast between the lines in the grid 105A and the space there between or therein, and the interruption of the grid 105A provided by the article 101 disposed thereon and between an optical member or camera and the grid 105A, may be used with a laser scanning apparatus and/or an optical instrument to provide a signal to a controller (not shown in FIG. 1B) to run program code to interpret a signal from the laser scanner apparatus or to a controller (not shown in FIG. 1B) to run optical recognition program code to determine at least one dimension of the article 101 supported on the first member 105. Computer programs are available which can be run on a controller to receive data from a camera, laser scanner and/or optical device and thereby determine, with considerable accuracy, the size of the article 101 using the image the article 101 imparts to the grid 105A.

Optionally, the kiosk 102 may provide an article enclosure (not shown) for use by the user such as, for example, a transparent plastic or cellophane bag that may be used by the user to contain the article(s), to separate the article(s) from others in the storage member of the kiosk 102, and to assign to the article a specific identifying code or marking such as, for example, a number, a series of letters, an alphanumeric code, a Matrix (2-D) code or a bar code. For example, but not by way of limitation, the kiosk 102 of FIG. 1A may provide a container of clear, sealable bags or enclosures, each bearing a unique and computer-readable bar code that identifies the bag and assigns a code to the contents of the bag. The enclosures may be dispensable one at a time from the container and made accessible to the user through, for example, a slot. The user may remove one enclosure from the slot, insert an article within the enclosure, seal the enclosure and then place the enclosure with the article therein on the first member for determining a property of the article. The enclosure may be, for example, a sealable transparent bag, and the bag may be of such construction as to be of insignificant mass compared to the article deposited within the bag such as, for example, coins or jewelry, so that the bag does not significantly affect any subsequent determination of the mass or other property of the article. In the event that the user then authorizes retention of the article within the kiosk, the enclosure may be scanned to determine a code disposed thereon, such as a bar code or a matrix (2D) code, the code may be assigned to the article and to the transaction involving the article, and the enclosure and the article therein may be moved to a second member of the kiosk (see FIG. 1A) and remain in the enclosure to maintain segregation from other articles that may later be or that have earlier been moved to the second member of the kiosk for storage therein and subsequent collection and inspection.

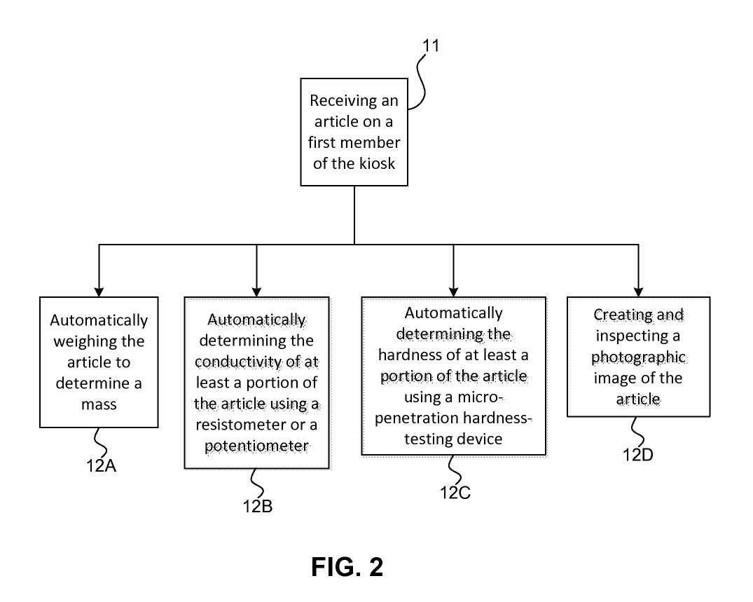

FIG. 2 is a flowchart generally illustrating alternative embodiments of the method step of determining a property of the article deposited by the user on the first member of the kiosk. FIG. 2 illustrates the step 11 of receiving an article on a first member of the kiosk as it was illustrated in FIG. 1. That step 11 is shown as the step prior to and leading to the alternative embodiments 12A, 12B, 12C and 12D of the step of determining a property of the article 12 from FIG. 1. In one alternative step 12A, the article is weighed to determine the mass of the article. In one alternative step 12B, the article may be contacted by a conductive element to determine the conductivity of at least a portion of the article. In one alternative step 12C, the hardness of at least a portion of the article may be determined using, for example, a micro-penetration hardness testing device. In another alternative step 12D, a photographic image of the article is created and inspected to determine a property of the article. It should be understood that embodiments of the method may comprise other alternative steps of determining a property of the article, and that the alternative embodiments of the step illustrated in FIG. 2 should not be considered as limiting of the invention. It should be further understood that certain embodiments such as, for example, the embodiments of the step illustrated in steps 12A-12C may be automated. For example, but not by way of limitation, the alternative step 12A, in which the article is weighed to determine the mass of the article, may comprise the step of using a controller to detect the presence of a mass on the first member, the step of using the controller to activate a scale that supports the first member to generate a signal corresponding to the measured mass of the article, receiving the signal at the controller for use in calculations performed by additional steps such as, for example, receiving into the controller a user input indicating the material of which the article is comprised, using the controller to access a stored and/or updated value for the material indicated by the user, using the controller to multiply the mass times the stored and/or updated value and using the controller to determine a preliminary offer to purchase the article. Alternately, in the alternative step 12B, in which the conductivity of the article is determined by contacting the article with one or more conductive elements to determine the conductivity of at least a portion of the article, one embodiment of the step may comprise the step of using a controller coupled to at least one of a scale that supports the first member and a motion detector disposed adjacent to the first member to detect the presence of a mass on the first member, using the controller to position one or more conductive elements adjacent the first member to contact at least a portion of the article, using the controller, coupled to a current source, to pass a micro-current through at least a portion of the article, using the controller to measure the conductivity and/or resistivity of the at least a portion of the article contacted by the one or more conductive elements, using the controller to compare the measured conductivity and/or resistivity to a database of values corresponding to conductivity and/or resistivity of a plurality of materials of known composition, using the controller to select a material having a conductivity and/or resistivity closely corresponding to the measured conductivity and/or resistivity of the article, using the controller to select a value corresponding to the selected material from a database of stored and/or updated values corresponding to a plurality of materials, using the controller to multiply the mass times the stored and/or updated value and using the controller to determine a preliminary offer to purchase the article.

It should be understood that, in other embodiments of the method, a property of the article may be determined with human involvement such as, for example, step 12D may comprise the steps of using a controller to detect the presence of a mass on the first member or using a motion detector to detect the presence of the mass on the first member, using the controller and a camera to create a photographic image of the article, using the controller and an email program or a transmitter to deliver the photographic image, along with other related information or data, by cellular telephone communications or by use of a network, to a technician or attendant at a location remote from the kiosk into which the article is deposited by the user, using the controller to receive from the technician or attendant a code and/or a preliminary offer associated with the technician's or attendant's inspection of the photographic image, either alone or in combination with a measured mass using a scale coupled to the controller, and displaying the preliminary value to the user as described in more detail below.

It should be understood that a “property,” as that term is used herein in connection with the step of determining a property of the article provided by the user, may include, but is not limited to, the weight, density, mass, shape, size, hardness, material composition, conductivity, resistivity, magnetic properties, photographic image, light and particle bombardment reflection and refraction properties, and material properties relating to the absorption, reflection and/or emission of radioactivity or neutrons.

In one embodiment, any one of a variety of barriers movable between a blocking position to prevent user access to the first member and a removed position to permit user access to the first member, may be moved to the blocking position between the article and the first member, after the article is placed on the first member, and the user to prevent unwanted tampering with the first member during the process of determining a property of the article. The movable barrier may be moved using, for example, a fluid cylinder and/or an electric motor coupled to the controller. In another embodiment, the barrier may be manually closable and/or openable. Such a barrier may also prevent possible injury to the user.

In another alternate embodiment, for example, the property of the article determined in the step is weight and/or mass using, for example, a centrifuge to measure force imparted by the article on a first member and by the first member on the article as the article is accelerated from a resting position to a velocity. For example, this alternate step could be used in a method involving a centrifuge device to determine a mass. In another alternate embodiment, a device having one or more conductive elements such as, for example, flexible filaments, may engage the article to complete an electrical circuit comprising the one or more conductive elements, the article and the first member so that a current, resistance, conductivity or other electrical property of at least one material of the article contacted by one or more conductive element may be determined using the controller.

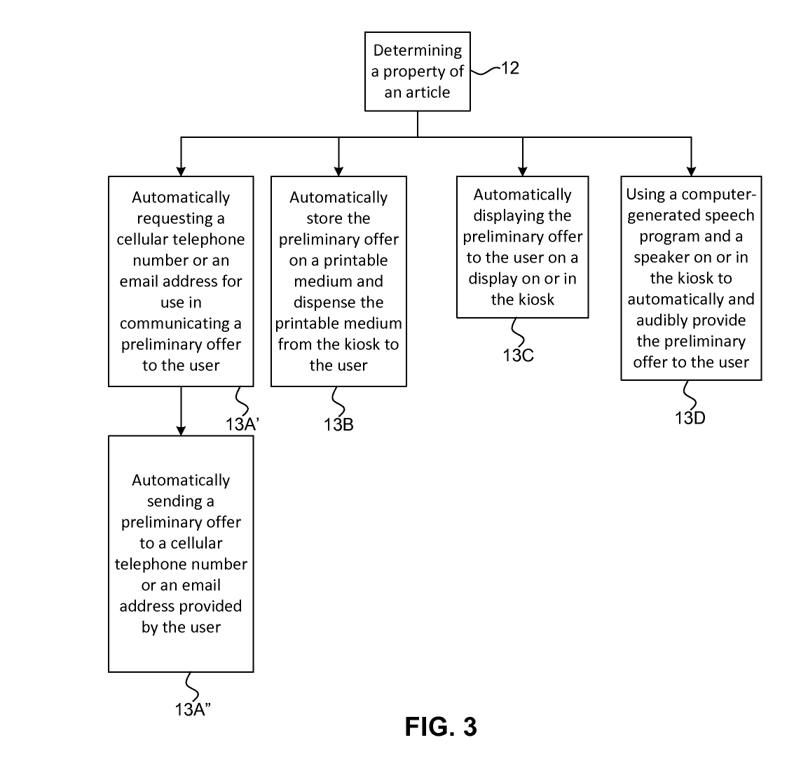

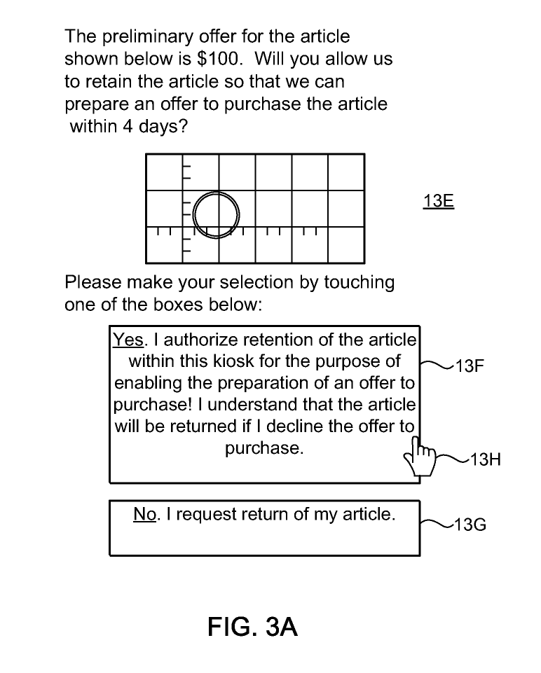

FIG. 3 is a flowchart generally illustrating alternative embodiments of the method step of communicating a preliminary offer to the user. In one embodiment of the method of communicating a preliminary offer to the user comprises the step 13A′ of using a controller to display to the user a request for the user's entry of a cellular telephone number or email address, followed by the step 13A″ of sending the preliminary offer to a cellular telephone number or to an email address provided by the user. It will be understood that the method step illustrated in step 13A′ may be implemented using a keypad, keyboard or a touch-sensitive display screen on the kiosk for use by the user in inputting his or her telephone number or email address. It will further be understood that this alternative embodiment of the step of receiving the user's authorization to retain the article within the kiosk may be preferred by those that carry cellular telephones or personal digital assistants (PDAs) at which they can receive an email.

An alternate embodiment of the method comprises the method step of communicating the preliminary offer to the user may comprise the step of using a controller to generate a signal to a printer to print a preliminary offer on a printable medium and dispense the printable medium bearing the preliminary offer to the user, as illustrated in step 13B or, alternately, using a controller to generate a signal to a display device such as, for example, a monitor, a cathode ray tube, an LED screen, a LCD screen, a plasma screen, and/or a touch-sensitive display screen visible to the user as illustrated in step 13C. For example, the step of communicating the preliminary offer to the user may comprise the step of displaying the preliminary offer to the user on a monitor, a cathode ray tube, an LED screen, a LCD screen, a plasma screen and/or using a printable medium, and by then requesting that the user use one of two (or more) alternative buttons, levers, keys, codes or commands that are accessible to the user on the kiosk, for example, a first button for use by the user to authorize the retention of the article within the kiosk and a second button to enable the user to request return of the article.

FIG. 3A illustrates an example of how the preliminary offer might be displayed on a touch-sensitive screen 13E. The step communicating the preliminary offer to the user may comprise the step of displaying the preliminary offer to the user on a touch-sensitive display screen 13E and by providing, on the same screen 13E, a first selectable icon 13F, for touching by the user to authorize retention of the article within the kiosk, and a second selectable icon 13G, for touching by the user to request return of the article to the user.

As an alternative to the use of a touch-screen display, a mouse or a track-ball may be provided for use by the user in selecting an option by moving the mouse or track-ball until a cursor or selector icon 13H appears to “hover” over the intended selection. The user may then press a button on the mouse, the track-ball or a button adjacent to the track-ball to make his or her selection.

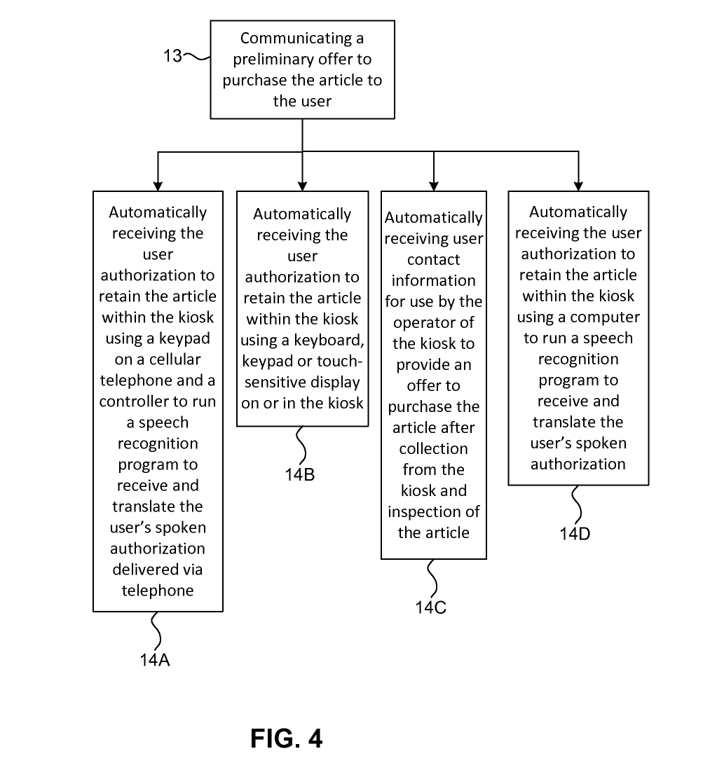

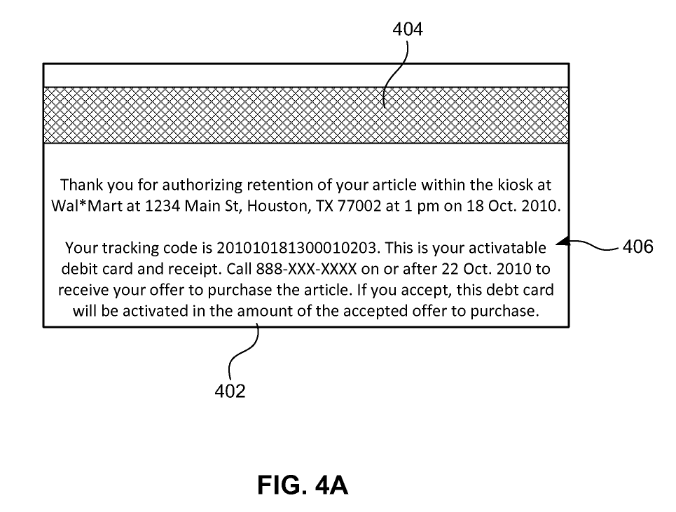

FIG. 4 is a flowchart generally illustrating alternative embodiments of the method step of receiving a user authorization to retain the article within the kiosk. One embodiment of the method illustrated in FIG. 3A comprises the step of using a controller to display and/or activate one or more selectable icons or buttons, respectively, to enable the user, by touching or selecting one of two or more alternative selectable icons displayed on a touch-sensitive screen, or by pressing one of two or more selectable buttons on the kiosk 102 (see FIG. 1A), to authorize the retention of the article within the kiosk by sending a signal to the controller. Another embodiment of the method of receiving a user authorization to retain the article within the kiosk comprises the step 14A of using a controller to run a voice-recognition program to receive, by way of a speaker on the kiosk or by way of a speaker on a telephone, and interpret the user's response to a request, on the user's cellular telephone telephonically coupled to the controller. Another embodiment of the method of receiving a user authorization to retain the article within the kiosk comprises the step 14B of providing a controller coupled to at least one of a keypad, a keyboard and a touch-sensitive display screen to detect the user's entry of a code or selection of an icon corresponding to authorization for retention of the article within the kiosk. Another embodiment of the method of receiving a user authorization to retain the article within the kiosk comprises the step 14C of using a controller coupled to an input device, such as a keypad or keyboard, receiving user contact information for use by the operator of the kiosk to provide an offer to purchase. It should be understood that user contact information for providing an offer to purchase may include options other than immediate-delivery alternatives that are more likely to be used for delivering the preliminary offer, and may include, for example, but not by way of limitation, a mailing address, a business phone number, a fax number and/or a home telephone number. Another embodiment of the method of receiving a user authorization to retain the article within the kiosk comprises the step 14D of using a controller coupled to a speaker to run a speech-recognition program to receive and translate or transform a spoken response of the user to the inquiry of whether the article may be retained within the kiosk for subsequent collection and inspection. For example, but not by way of limitation, a speaker mounted on or near the kiosk (see FIG. 1A), or a telephone handset on the kiosk, could all be used in conjunction with the controller to receive the user's authorization.

In one embodiment of the method, the kiosk may, in response to receiving the user's authorization to retain the article within the kiosk as shown in FIG. 3A, dispense an information storage medium in the form of, for example, but not by way of limitation, a debit card 402 like the one illustrated in FIG. 4A and having a magnetic strip 404 to receive and store information relating to at least one of the articles, the user, the preliminary offer, the kiosk 102 and other data that may be pertinent to the proposed purchase. In one embodiment of the method, and as illustrated in FIG. 4A, the debit card 402 may also bear instructions 406 to be used by the user to obtain an offer to purchase the article deposited by the user in a kiosk. In one embodiment of the method, the debit card 402 may contain a computer-readable code magnetically stored on or within the magnetic strip 404 such that the debit card 402 is identifiable to a computer having a magnetic strip reading device. In this embodiment of the method, the debit card 402 may be activatable upon acceptance by the user of an offer to purchase the article made, for example, by telephone and accepted by the user, by example, by telephone.

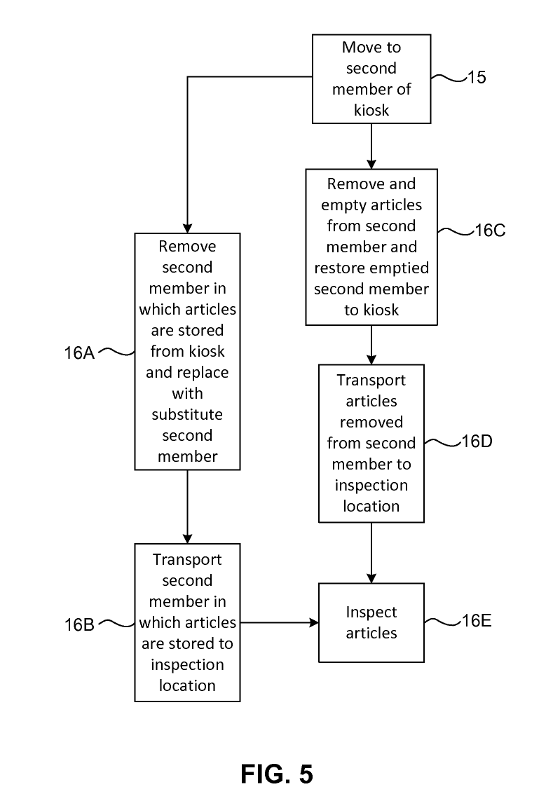

One embodiment of the method, after the step of receiving the user's authorization to retain the article within the kiosk, comprises the steps of collecting the article(s) stored in the kiosk and inspecting those articles so that an offer to purchase may be provided to the user. FIG. 5 is a flowchart generally illustrating alternative embodiments of collecting and inspecting the articles stored in the kiosk. After the user's authorization to retain the article within the kiosk is received and the article is moved to the second member of the kiosk for storage, as in step 15, one embodiment of the method comprises the step 16A of removing the second member in which the article is stored and replacing the second member with a substituted second member. This method provides for securing the articles within a container such as, for example, a case, for the following step 16B of transporting the removed second member to an inspection center. An alternate embodiment of the method comprises the steps 16C of removing and emptying the second member in which the article is stored and restoring the emptied second member to the kiosk for use in storing later-retained articles from the same or other users. Step 16C is followed by step 16D in which the removed articles are transported to an inspection location. Both of the embodiments of the method illustrated by steps 15, 16A and 16B, on the one hand, and steps 15, 16C, and 16D, on the other hand, are followed with the step 16E of inspecting the article from the second member of the kiosk so that an offer to purchase may be generated and communicated to the user.

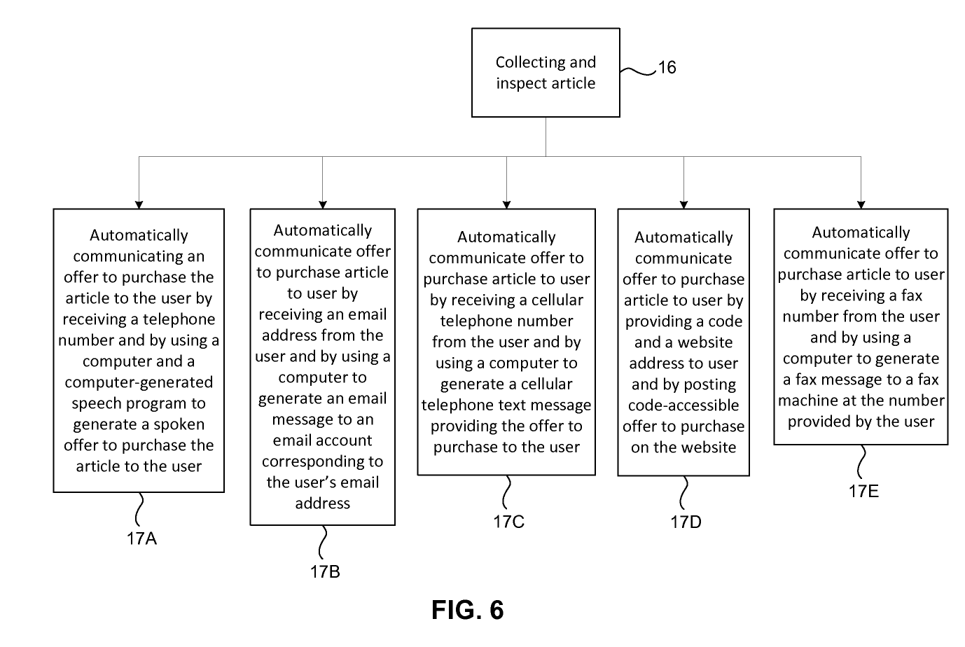

FIG. 6 is a flowchart generally illustrating alternative embodiments of the step of communicating an offer to purchase the article to the user. One embodiment comprises the step 17A of using a controller, coupled to a telephone, to run a speech-generation program to speak the offer to purchase to the user using the telephone. In this embodiment of the method, the telephone number of the user may have been, for example, obtained from user upon receiving the user's authorization to retain the article within the kiosk. For example, but not by way of limitation, in one embodiment of the method, the user may use the instructions provided on the debit card 402 illustrated in FIG. 4A to obtain the offer to purchase. The user may call the phone number indicated thereon and identify the transaction corresponding to the tracking number. The phone number and tracking number are illustrated as included within the instructions 406 displayed on the debit card 402 illustrated in FIG. 4A. The controller may, in step 17A of FIG. 6, receive and translate the tracking number spoken to the controller by the user to access a database and, upon locating the offer to purchase corresponding to that particular article and tracking number, the controller may use a computerized speech-generation program to “speak” the offer to purchase to the user via the telephone and request the user's response. One alternate embodiment of the method comprises the step of communicating the offer to purchase to the user is illustrated in step 17B as using a controller, coupled to a network (via, for example, an Internet connection—see element 116 of FIG. 1A) to run an email program and to generate an email containing the offer to purchase and send the email, via a network connection 116, to the user. Another embodiment of the method comprises the step 17C of using a controller, coupled to a telephone, to run a text message generation program to generate and send a text message to the user's cellular telephone. These alternate embodiments of the method may both require the use of a cellular telephone number provided by the user upon authorizing the retention of the article within the kiosk. An alternate embodiment of the method comprises the step 17D of using a controller to receive a code from the user and to access a database in which offers to purchase articles are stored. The offers to purchase articles are stored in the database and associated with specific tracking codes assigned to the article upon receiving the user's authorization to retain the article within the kiosk. The user may access an Internet website operated by the operator of the kiosk, enter the tracking code to prompt the controller to access and provide the offer to purchase corresponding to the tracking code entered by the user. An alternate embodiment of the method comprises the step 17E of using a controller coupled to a fax machine to generate and to send the user a fax at a fax machine number provided by the user at the time of receiving the user's authorization to retain the article within the kiosk.

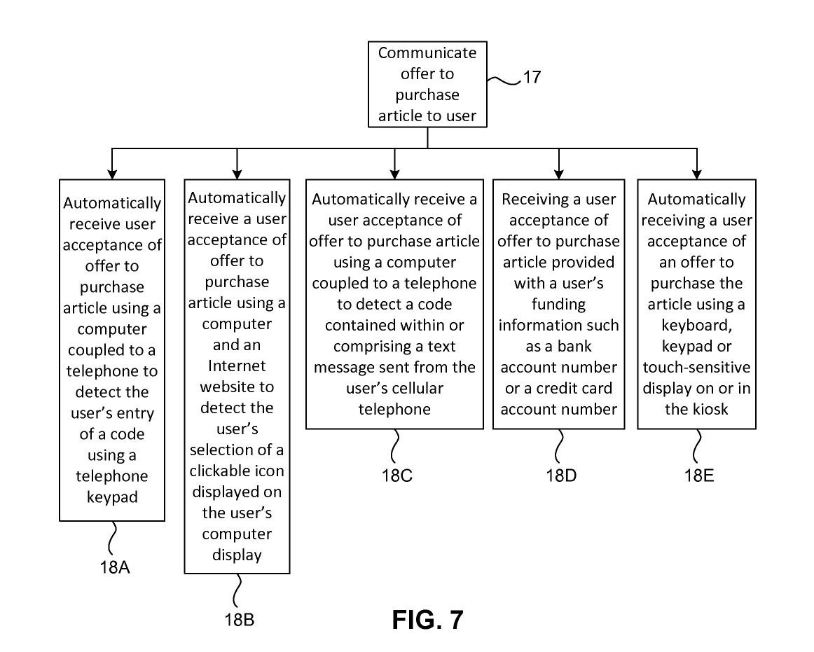

After the offer to purchase the article is generated and communicated to the user, the user may accept the offer to create a contract for the sale and purchase of the article. FIG. 7 is a flowchart generally illustrating alternative embodiments of receiving a user's acceptance of the offer to purchase the article. An embodiment of the method corresponding to the use of instructions on the debit card 402 illustrated in FIG. 4A may comprise the step 18A of using a controller coupled to a telephone to receive and translate the user's entry of a code using a keypad of a telephone. For example, if the controller were to use the telephone to communicate the offer to purchase to the user via a controller-driven speech-generation program, the same generated message may include the follow-up or confirmatory instruction to “Press 1 to accept, or press 2 to reject the offer.” Upon detecting the tone transmission affiliated with the user's pressing of the “1” key on the telephone keypad to accept the offer to purchase, the controller could then use the speech-generation program to reply “You have elected to accept the offer to purchase.” One alternate embodiment of the method comprises the step 18B of receiving the user's acceptance of the offer to purchase the article using a controller connected to a network to detect the user's selection of a clickable icon on a website that may be operated by the operator of the kiosk and accessed by the user. Another embodiment of the method may comprise the step 18C of receiving the user's acceptance of the offer to purchase the article using a controller coupled to a telephone or to an electronic network to receive and detect a code within a text message sent by the user using a cellular telephone and received at the controller through the telephone to which it is coupled. Another alternate embodiment of the method comprises the step 18D of receiving the user's acceptance of the offer to purchase the article using a controller to receive and process a user's funding information such as, for example, a bank account number to which a deposit in the amount of the accepted offer to purchase may be made or a credit card number corresponding to a credit card account to which a credit in the amount of the accepted offer to purchase may be electronically directed. Another alternate embodiment of the method of receiving the user's acceptance of the offer to purchase the article may comprise the step 18E of using a controller to receive a user acceptance of an offer to purchase the article using a keyboard, keypad or touch-sensitive display on or in the kiosk. For example, but not by way of limitation, a controller may be coupled to a cellular telephone, an email program or a fax machine and deliver the offer to purchase to the user via text message, email or fax, and it may solicit the user's response to the text message, email or fax by providing a controller-readable code, a bar code or a matrix (2D) code that can be printed by the user or saved by the user on his or her cellular telephone and presented at the kiosk, or at an associated kiosk, to be read by the controller and interpreted as acceptance of the offer to purchase so that purchase funds may be transferred to the user. Optionally, an offer to purchase may be accepted by the user by contacting a representative of the operator of the kiosk by telephone and verbally accepting the offer.

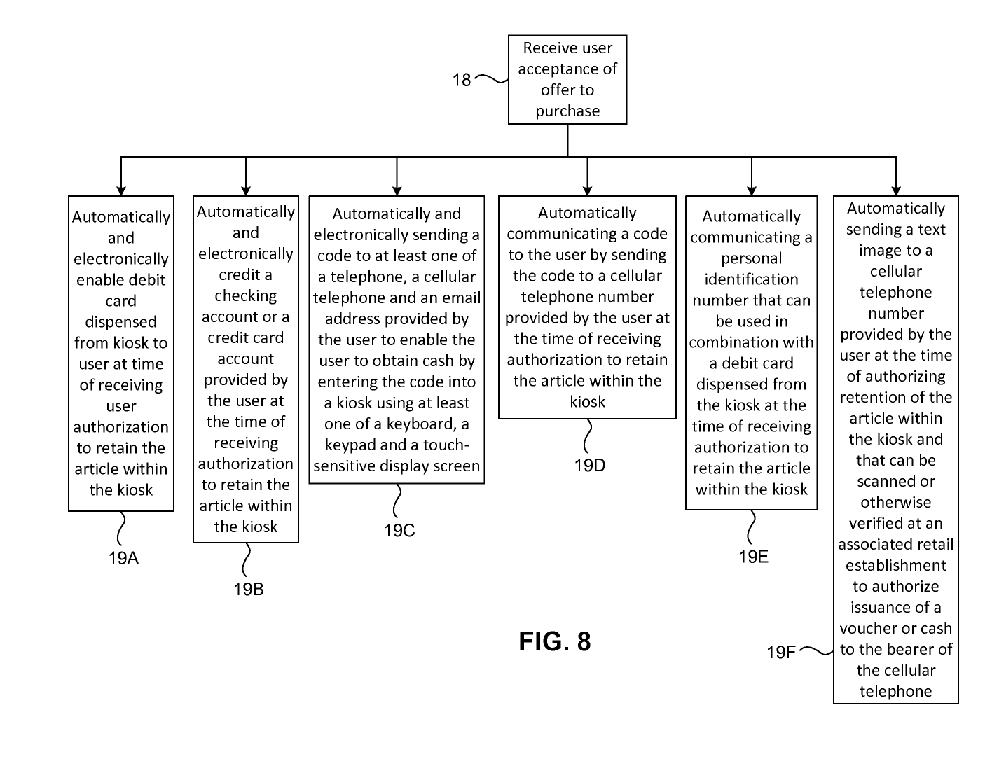

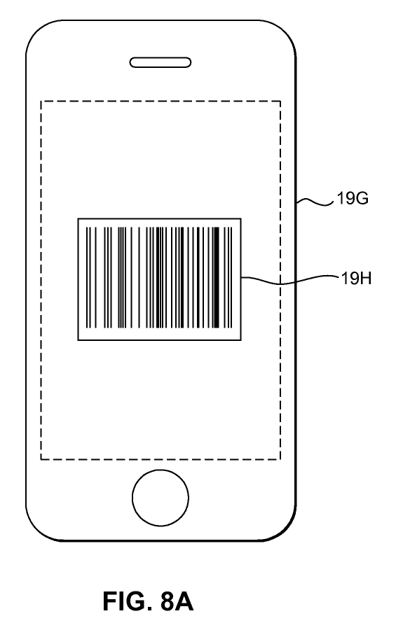

After the step of receiving the user's acceptance of the offer to purchase, embodiments of the method may comprise the step of transferring purchase funds to the user. FIG. 8 is a flowchart generally illustrating alternative embodiments of transferring funds to the user. One embodiment of the method comprises a step 19A, that is related to the illustration in FIG. 4A, in which the operator of the kiosk may electronically activate a debit card 402 (see FIG. 4A) dispensed from the kiosk at the time of receiving the user authorization to retain the article within the kiosk. The debit card may be activated by, for example, using a controller to electronically authorize a bank to credit an account corresponding to the debit card 402, or as shown in step 19B, by using a controller to electronically authorize a bank or credit card company to credit an account provided by the user at the time of receiving authorization to retain the article, in the amount of the accepted offer to purchase. Another embodiment of the method comprises the step 19C (of FIG. 8) of using a controller coupled to a telephone or to a network to send an audible, text or email message providing a code to the user (via his or her telephone, cellular telephone or computer) that can be presented at the kiosk, and by using the controller to receive and recognize the code and to dispense purchase funds in cash or to dispense a debit card. It should be understood that the code may be a legible (to humans) code such as, for example, code to be read by the user and entered into the kiosk through a keypad, keyboard or touch-sensitive display screen.

Another embodiment of the method comprises the step 19D of using a controller coupled to a telephone or to a network to send an image such as, for example, a code, bar code, a matrix (2D) code or a computer readable code to a cellular telephone number provided by the user. FIG. 8A illustrates how a code such as, for example, the bar code 19H, might be received by and then displayed on the screen of a user's cellular telephone 19G in a manner that makes it easily stored and saved, easily retrieved, and easily presented for scanning at a kiosk or other scanner affiliated with the operator of the kiosk.

Returning to FIG. 8, another embodiment of the method comprises the step 19E of communicating a personal identification number (PIN) that can be used in combination with a debit card dispensed from the kiosk at the time of receiving the user's authorization to retain the article within the kiosk. The PIN may be communicated to the user by any of the methods stated herein for communicating an offer to purchase, for example, via email, text message, telephone, fax, etc.

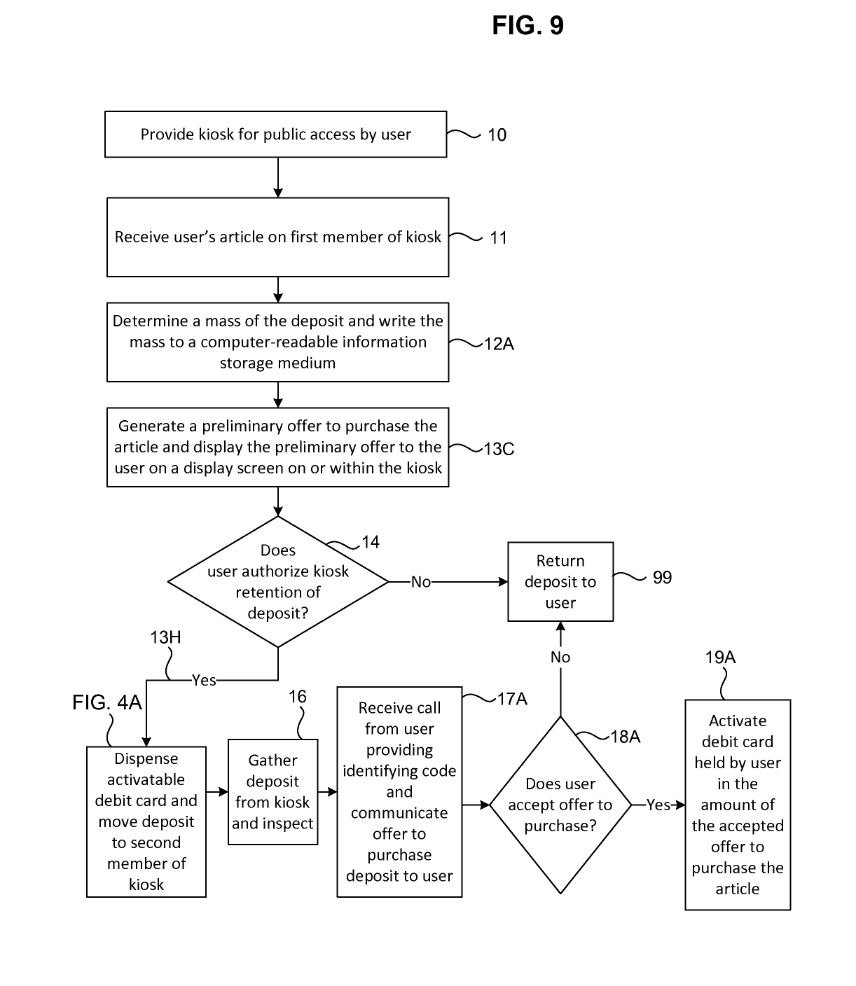

FIG. 9 is a flowchart generally illustrating a preferred embodiment of the method utilizing at least one of the alternative method steps from each of FIGS. 2 through 8 in order to carry out a complete transaction using a process comprising automated steps. It should be understood that the various steps illustrated on FIG. 9 are assigned element numbers corresponding to steps and/or alternative steps described in FIGS. 2 through 8 and that each step is described above in the discussion of those steps and/or alternative steps. It should be understood that there are many combinations of steps that may be assembled to practice the method and to provide an apparatus for carrying out the method of the invention, and that no particular combination should be considered as limiting. It should be understood that the determination of a property of the article provided by the user at the kiosk is a step common to all embodiments of the method as it facilitates, through the various embodiments of the method disclosed herein, the formation of a contract between the user and the operator of the kiosk for the purchase, by the operator of the kiosk, and the sale, by the user, of the article. It should be understood that the foregoing embodiments may also be considered as a method of interactively marketing the brokerage services of the operator of the kiosk in that the operator of the kiosk may provide and operate the kiosk in the manner herein disclosed to provide data and/or information concerning the article to the user as part of the solicitation of the user to avail himself or herself of the services available to the user through his or her use of the kiosk. The step of determining a property of the article provides the opportunity to automatically and inexpensively generate and provide data and/or information that promotes the user's consideration of selling the article.

In one embodiment, the method further comprises accessing a database having data pertaining to a series of transactions involving the user and providing a user bonus added to the amount of the offer communicated to the user. In this embodiment, a purchase value multiplier may be applied to reward the user for submitting and selling high-quality articles in the past, for submitting and selling a large volume of articles in the past, being accurate in his or her responses to kiosk inquiries relating to the nature and composition of the articles submitted in the past, etc. In one embodiment, the purchase value multiplier is used to calculate a bonus amount that is emphasized on a transaction receipt dispensed to, or an electronic receipt sent to, the user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. The term “network,” as that term is used herein, should be given a broad meaning. For example, in the latter scenario, the remote computer on which program code may be executed may be connected to the kiosk through any type of network, including, but not limited to, a local area network (LAN) or a wide area network (WAN), or the connection may be made to an external computer (for example, through the Internet using an Internet Service Provider). It should be understood that cellular telephone communications are, for purposes of this disclosure, included within the meaning of the term “network.” It should be further understood that data may be retrieved from a centralized database accessible by the kiosk controller through a network, or the data may be retrieved by the controller from a database stored in the kiosk and updated from a centralized database.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof.

The term “article,” as that term is used in this application, means one or more articles, and may specifically a single article or a plurality of articles. The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

From the foregoing detailed description of specific embodiments of the invention, it should be apparent that an apparatus and a method for facilitating the purchase of an article comprising a precious material are herein disclosed, and that an apparatus and a method for automating the process of screening potential and/or prospective sellers of articles comprising a precious material are disclosed. Although specific embodiments of the apparatuses and methods are disclosed herein, this is done solely for the purpose of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow. While embodiments of the invention have been described herein, various modifications of the apparatus and method of the invention may be made without departing from the spirit and scope of the invention, which is more fully defined in the following claims.

We claim:

1. A method to facilitate the purchase of an article comprising:
providing a kiosk for access by a user;
receiving an article from the user on a first member of the kiosk;
determining a property of the article;
using a controller to run a program code to generate a signal corresponding to the determined property of the article;
using a controller to run a program code to generate a preliminary offer to purchase the article corresponding to the determined property of the article;
using the controller to run a program code to communicate the preliminary offer to the user;
using the controller to run a program code to receive the user's authorization to retain the article at the kiosk;
using the controller to run a program code to actuate an apparatus to move the article to a second member of the kiosk;
providing a transaction identifying code to the user;
collecting the article from the second member;
inspecting the article;
using a controller to receive and store an offer to purchase the article in a computer-readable storage medium;
receiving the transaction identifying code from the user;
retrieving the offer to purchase the article from the computer-readable storage medium;
communicating the offer to purchase the article to the user;
receiving an acceptance from the user of the offer to purchase the article; and
transferring purchase funds to the user;
wherein the offer to purchase the article is determined based on the inspection of the article.

2. The method of claim 1 wherein the step of transferring purchase funds to the user comprises:
using a controller to run a program code to dispense an activatable debit card from the kiosk to the user after receiving the user's authorization to retain the article within the kiosk; and
activating the debit card.

3. The method of claim 1 wherein the step of transferring purchase funds to the user comprises:
dispensing to the user a print medium bearing at least one of the transaction identifying code and a code corresponding to the offer to purchase article;
using a controller connected to a scanner to run a program code to scan the print medium and detect the at least one of the transaction code and the code corresponding to the offer to purchase the article; and
authorizing payment of an amount corresponding to the offer to purchase the article to the user.

4. The method of claim 3 further comprising at least one of:
dispensing cash to the user; and
dispensing a redeemable voucher to the user.

5. The method of claim 1 wherein the step of receiving a user authorization to retain the article within the kiosk comprises at least one of:
receiving the user's telephone number;
receiving the user's email address;
receiving the user's fax number;
receiving the user's credit card account number; and
receiving the user's checking account number.

6. The method of claim 1 wherein the step of using the controller to run a program to actuate an apparatus to move the article to a second member of the kiosk comprises:
receiving a signal from the user to the controller; and
using the controller to run a program to activate an apparatus actuator to move the article to the second member of the kiosk.

7. The method of claim 1 wherein the step of providing a transaction identifying code to the user comprises at least one of:
using a controller coupled to a telephone to run a program to call a telephone number provided by the user and then using the controller to run a computer speech-generation program to communicate the transaction identifying code to the user;
using a controller coupled to a network to run an email program to send an email providing the transaction identifying code to an email address provided by the user;
using a controller coupled to a fax machine to run a program to call a fax number provided by the user and then to provide a transaction identifying code using a computer-generated fax; and
using a controller coupled to a cellular telephone to run a program to send at least one of an image and a text message to a cellular telephone number provided by the user.

8. The method of claim 1 wherein the step of transferring purchase funds to the user comprises:
automatically transferring purchase funds to the user by at least one of: activating an activatable debit card dispensed after receiving the user's authorization to retain the article within the kiosk; and
authorizing payment to the user for presenting a print medium that was dispensed from the kiosk to the user upon receiving the user's authorization to retain the article within the kiosk.

9. The method of claim 1 wherein the step of transferring purchase funds to the user comprises at least one of:
dispensing cash from the kiosk;
dispensing a debit card from the kiosk;
providing a deposit to an account related to the user's debit card;
providing a credit to a credit card account provided by the user;
dispensing a gift card to the user; and
crediting an account belonging to the user.

10. The method of claim 1 further comprising the step of:
using a controller coupled to a camera to run a program to create a photographic image of at least one of the article and the user; and
using the controller to run a program to storing the photographic image on a computer-readable storage medium.

11. The method of claim 10 further comprising:
using the controller to run a program to compare the photographic image to a plurality of photographic images stored in an accessible database; and
identifying one or more photographic images in the database that match the photographic image of the at least one of the article and the user.

12. The method of claim 1 wherein the step of determining a property of the article comprises;
weighing the article to determine the mass.

13. The method of claim 1 wherein the step of using the controller to run a program code to receive the user's authorization to retain the article at the kiosk comprises:
providing at least one of a touch-sensitive display screen, a keyboard and a keypad for access by the user; and
connecting the at least one of the touch-sensitive display screen, the keyboard and the keypad to the controller.

14. An automated method to facilitate the purchase of an article comprising a precious material comprising:
providing a kiosk having a movable barrier, a first member, a second member and a controller;
receiving an article comprising a precious material on the first member;
disposing the barrier between a user and the first member;
generating a signal to the controller corresponding to a determined property of the article;
using the controller to run program code to generate a preliminary offer to purchase the article;
using the controller to run program code to communicate the preliminary offer to the user;
using the controller to receive the user's authorization to retain the article at the kiosk; and
using the controller to run a program code to actuate an apparatus to move the article to the second member.

15. The method of claim 14 further comprising:
using the controller to run a program code to communicate a request for the user's contact information; and
using the controller to receive contact information provided by the user;
using the controller to run program code to record the user's contract information on a computer-readable storage medium;
wherein the user's contact information is providing to the controller through at least one of a keypad, keyboard and a touch-sensitive display screen at the kiosk.

16. The method of claim 14 further comprising:
providing an enclosure bearing a transaction identifying code to contain the article.

17. The method of claim 14 further comprising:
removing the article from the second member;
inspecting the article; and
communicating to the user an offer to purchase the article.

18. The method of claim 17 further comprising:
receiving a user acceptance of the offer to purchase the article; and
transferring purchase funds to the user.

19. The method of claim 14 further comprising:
using a camera to photograph at least one of the article and the user; and
using the controller to run a program code to record a photographic image on a computer-readable storage medium.

20. A method to facilitate the purchase of an article comprising:
providing a kiosk having a controller, a first member, a second member and a movable barrier;
receiving the article from a user on the first member;
automatically determining a property of the article;
automatically sending a signal corresponding to the determined property to the controller;
using the controller to run a program code to generate a preliminary offer to purchase the article based on the determined property;
automatically communicating the preliminary offer to the user; and
receiving a signal to the controller authorizing retention of the article at the kiosk; and
moving the article to the second member.

21. The method of claim 20 wherein the step of automatically determining a property of the article comprises:
providing a scale to weigh the article.
